(19) United States
(12) Patent Application Publication
(10) Pub. No.: US 2009/0112625 A1
(43) Pub. Date: Apr. 30, 2009

(54) Systems and Methods for Obtaining and Preserving Health Care Information

(76) Inventors: Holly S. Doherty, Chester, CT (US); Michele M. Schavior, Essex, CT (US)

Correspondence Address: GORDON & JACOBSON, P.C., 60 LONG RIDGE ROAD, SUITE 407, STAMFORD, CT, 06902, US

(21) Appl. No.: 11/923,935

(22) Filed: Oct. 25, 2007

(51) Int. Cl. G06Q 50/00

(52) U.S. Cl. 705/3

(57) ABSTRACT

An audiovisual system is provided and is programmed to collect information from a patient or a friend or relative of the patient through a series of questions. The questions are designed to elicit personal information about the patient that will be useful for future caregivers to know. Such information may include the patient's wants, needs, habits, strengths, weaknesses, and information that reveals the patient's personality and history. The answers to the questions are saved as an audiovisual record of the interview on a CD or DVD which can be viewed by present and future caregivers. Applications of the invention include adult patients entering a long term care facility, children entering a group home, etc.

### BACKGROUND OF THE INVENTION

1. Field of the Invention

This invention relates broadly to health care management. More particularly, this invention relates to automated systems and methods for collecting and preserving information about a patient or a ward which is useful for future care givers such as long term care providers or guardians in a group home.

2. State of the Art

For many years, various attempts have been made to apply information technology to the collection, processing and storage of medical information. For example, U.S. Pat. No. 5,867,821 discloses a method and apparatus for electronically accessing and distributing personal health care information and services in hospitals and homes. This is simply a central master library of medical information which is accessible from remote locations.

U.S. Pat. No. 6,046,761 discloses an interactive communication system for medical treatment of remotely located patients. The system includes two communications stations which are located remotely relative to each other. The doctor sits at one station and the patient sits at the other. The stations are provided with video cameras and video displays. The patient station also includes medical devices such as a blood pressure cuff, a thermometer, a heart rate monitor, etc. The system allows a remotely located patient to make a virtual visit to a doctor. The system is really directed to examination of remotely located patients. Treatment is limited to dispensing advice and prescriptions.

U.S. Pat. No. 6,692,436 discloses a health care information system which includes a kiosk with a touch screen display where a user can obtain general medical information by selecting from a menu displayed on the touch screen. The kiosk also includes a blood pressure cuff and a weighing scale in the seat so that the user can obtain a limited amount of medical information (weight and blood pressure) about themselves.

Published U.S. Patent Application Number 2004/0138924 discloses a system and method for intake of a patient in a hospital emergency room. The system provides a kiosk with an audio assisted touch screen that presents a number of intake questions to a patient in their preferred language to automate the repetitive component of the interviews of patients in hospital emergency rooms.

Published U.S. Patent Application Number 2006/0023163 discloses a kiosk that can perform eye examinations and published U.S. Patent Application Number 2006/0290885 discloses a kiosk that not only performs eye examinations but also dispenses corrective lenses based on the examination.

### SUMMARY OF THE INVENTION

The present invention provides an automated system and method for collecting and preserving information about a patient or a ward.

The inventors herein have recognized that patients in long term care do not get the best care they need and deserve because they are unable to communicate valuable information about themselves to their caregivers. Moreover, even in cases where the patient is able to initially communicate the information necessary for the highest quality care, there is no simple way to preserve this information. This becomes a problem for patients in long term care because of the normal turnover rate of caregivers at long term care institutions. This is also a problem where the patient's condition makes it difficult or impossible for them to communicate the information at a later date.

The inventors herein have also recognized that the patient information needed to provide long term care patients with the best level of care is not just medical information such as needed medications, allergies and history of disease. In fact, care providers and patients are often unaware that a substantial amount of non-medical information is useful in providing the highest quality of care.

According to one embodiment of the invention, an audiovisual kiosk is provided and is programmed to collect, through a series of questions, information which the inventors believe will help long term care providers provide a level of care that would not otherwise be obtainable. The information is saved as an audiovisual record of the interview on a CD or DVD which can be viewed by present and future caregivers.

According to one application of the invention, the kiosk is programmed to pose questions directly to the patient. The questions include personal information about the patient that will be useful for future caregivers to know. Such information may include the patient's wants, needs, habits, strengths, weaknesses, and information that reveals the patient's personality and history.

According to a second application of the invention, the kiosk is programmed to pose questions to a friend or relative of the patient who knows the patient very well and is able to supply personal information about the patient.

In either the first or second application, the user of the kiosk may opt not to answer some questions. In addition, the user may be provided with an opportunity to present unsolicited information which the user believes is important to obtain the highest level of care.

One primary application of the invention relates to adult patients entering a long term care facility. Another primary application of the invention relates to disabled children who may at some point enter a group home because their primary caregiver expects that they themselves will not be able to care for the child at that point in the future.

Unlike traditional methods of obtaining and preserving health care information, the present invention captures and preserves a very personal account of non-traditional information which gives care providers deep insight into the personality of the person under their care. This allows the care providers to give special care to the person, care which has special meaning for that person.

Additional advantages of the invention will become apparent to those skilled in the art upon reference to the detailed description taken in conjunction with the provided figures.

### BRIEF DESCRIPTION OF THE DRAWINGS

FIG. 1 is a schematic diagram illustrating a system according to the invention;

FIG. 1A is a schematic illustration of a kiosk embodying the invention;

FIG. 1B illustrates a personal computer embodying the invention;

FIG. 1C illustrates an internet based application embodying the invention;

FIG. 2 is a flowchart illustrating a method of using the system according to the invention;

FIG. 2A is a sample data entry screen;

FIG. 3 is a sample instruction screen according to a first application with touch sensitive buttons;

FIGS. 4-17 are samples of question and prompt screens with touch sensitive buttons according to a first application;

FIG. 18 is a sample instruction screen according to a second application with touch sensitive buttons; and

FIGS. 19-32 are samples of question and prompt screens with touch sensitive buttons according to a second application.

### DETAILED DESCRIPTION OF THE PREFERRED EMBODIMENTS

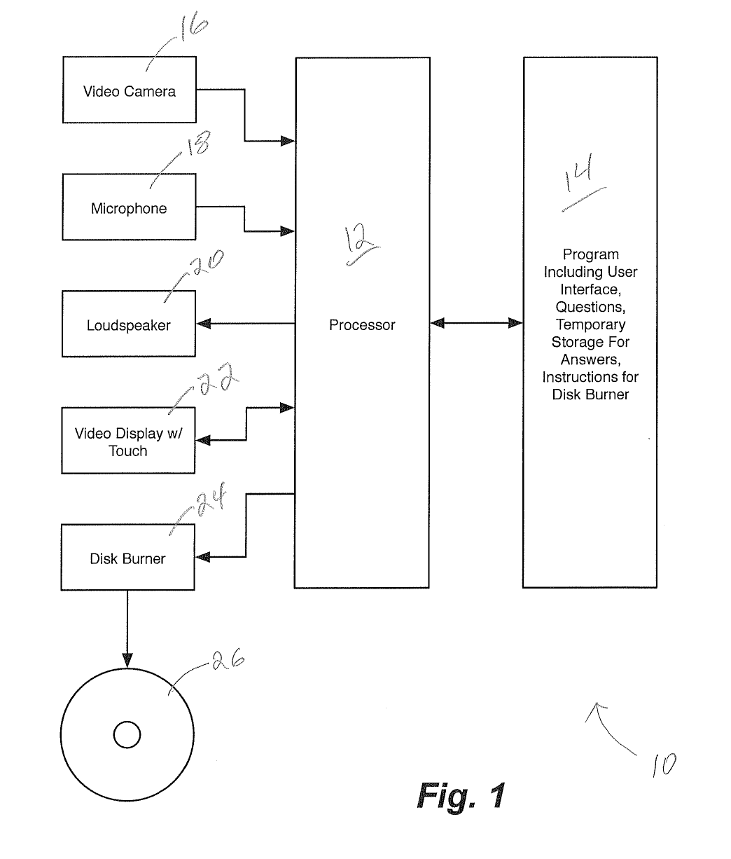

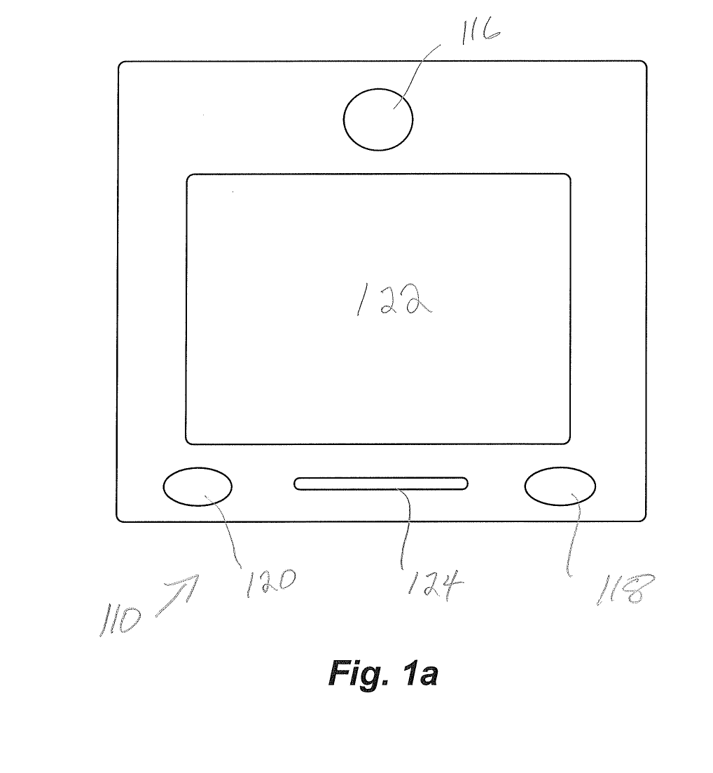

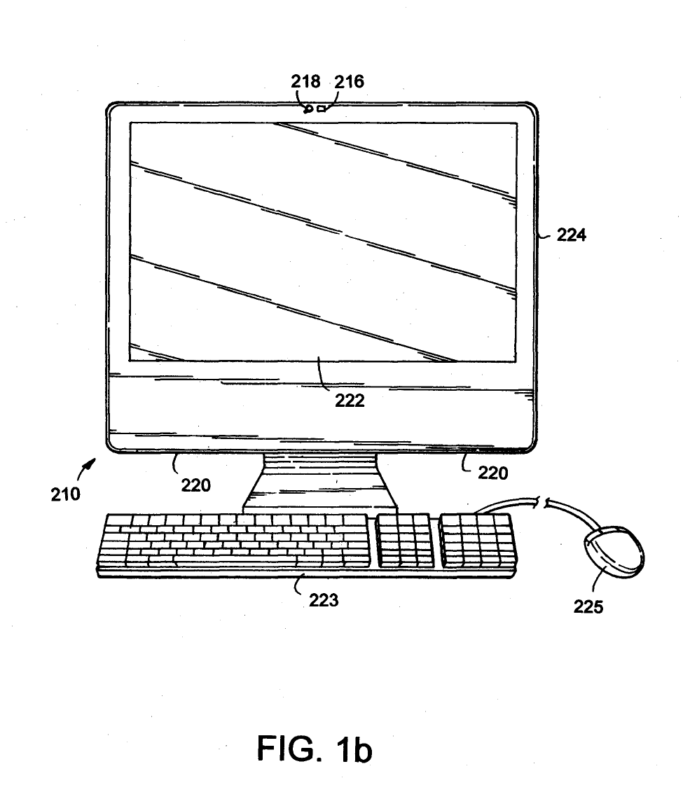

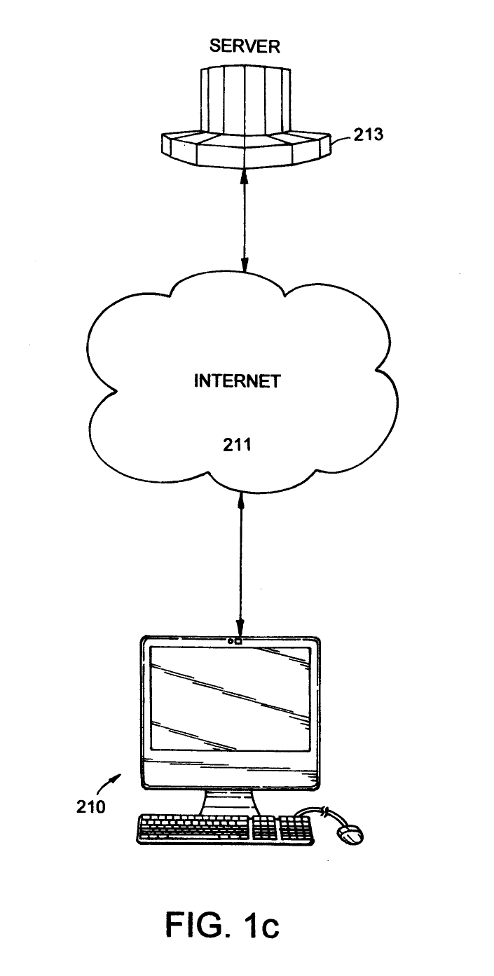

Turning now to FIG. 1, a system 10 for obtaining and preserving health care information includes a processor 12 and associated memory 14 bidirectionally coupled to the processor. The memory preferably includes non-volatile memory such as flash RAM for storing an operating system and an application program. The memory 14 may also include DRAM or SDRAM for temporarily storing obtained information before it is preserved in a non-volatile medium such as CD or DVD. The processor 12 is also provided with several input and output devices. For example, input to the processor is provided by a video camera 16 and a microphone 18. Output from the processor is provided to a loudspeaker 20, a video display 22, and a disk burner 24 with a removable disk 26. According to the presently preferred embodiment, the video display 22 is provided with a touch sensitive screen and is thus also used to provide input to the processor. The disk burner may be a CDR disk burner but a DVDR disk burner is presently preferred. It be appreciated that any present or future writable data storage medium can be used.

According to the invention, the memory 14 includes an interactive program which essentially “interviews” a user. An audiovisual presentation is provided via the loudspeaker 20 and the video display 22. The presentation includes questions and open-ended requests for information and a user-operated interface which includes touch sensitive “buttons” displayed on the screen of the video display. The user controls the pace and the content of the interview through the user-operated interface and provides answers to questions and requests via the microphone 18, video camera 16, and/or the touch sensitive display 22.

The system 10 is advantageously embodied in a kiosk such as the kiosks sold by Video Booth Systems, Ltd., Great Bentley, Essex, UK. These kiosks can be programmed to carry out the methods of the invention. However, other kiosks or an audiovisual equipped personal computer could also be programmed to carry out the methods of the invention. FIG. 1a shows a schematic illustration of a kiosk 110 having a video camera 116, a microphone 118, a loudspeaker 120, a touch screen video display 122 and a disk burner 124. It will be appreciated that the kiosk also includes a processor and memory which are not shown in FIG. 1a.

FIG. 1b illustrates an audiovisual equipped personal computer 210 which is programmed to carry out the functions of a video kiosk. The computer includes a video camera 216, microphone 218, loudspeakers 220, video display 222 and a disk burner 224. In the illustrated embodiment, the screen 222 is not touch sensitive and non-audiovisual input is effected with a keyboard 223 and/or mouse 225.

FIG. 1c illustrates yet another embodiment of apparatus according to the invention. Here the same audiovisual computer 210 as described above is not programmed to carry out the functions of a video kiosk, but rather accesses such a program on a server 213 via the internet 211. This can be performed in several ways. In one way, the program is accessed via a web site in which case some parts of the program may reside on the server 213 while some parts of the program are transferred to the computer 210. In another way, the entire program may be downloaded from the server to the computer. In either case, the resulting audiovisual file may be created on or transferred to the computer 210 which is programmed to burn a disk. Alternatively, the resulting audiovisual file may be kept on the server, transferred from the server to another storage location, or burned to a disk at the server or another location.

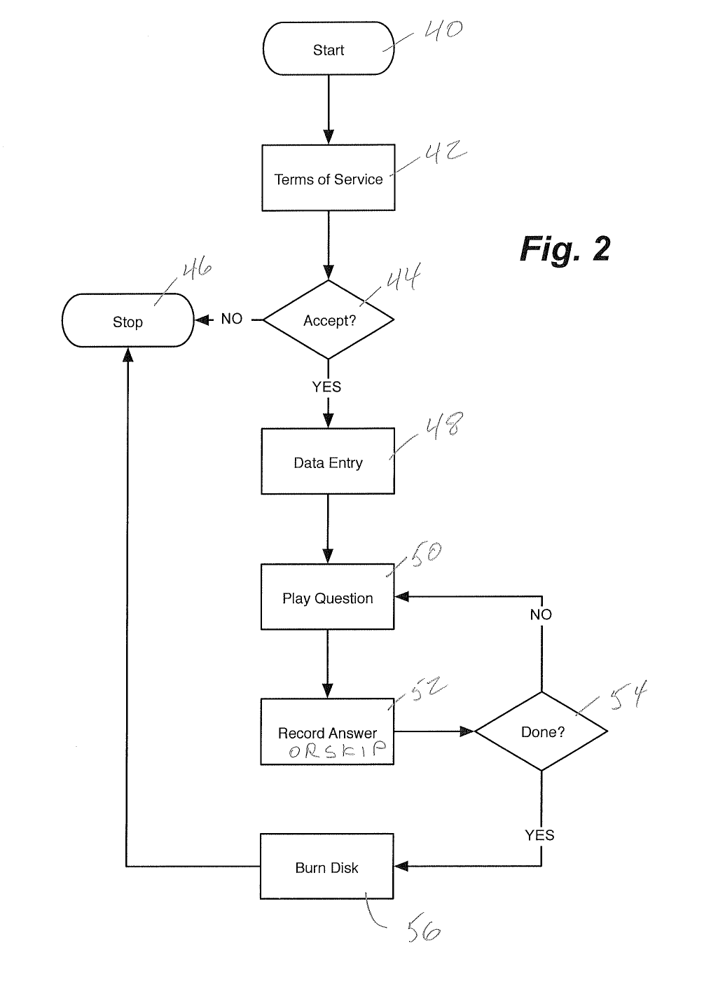

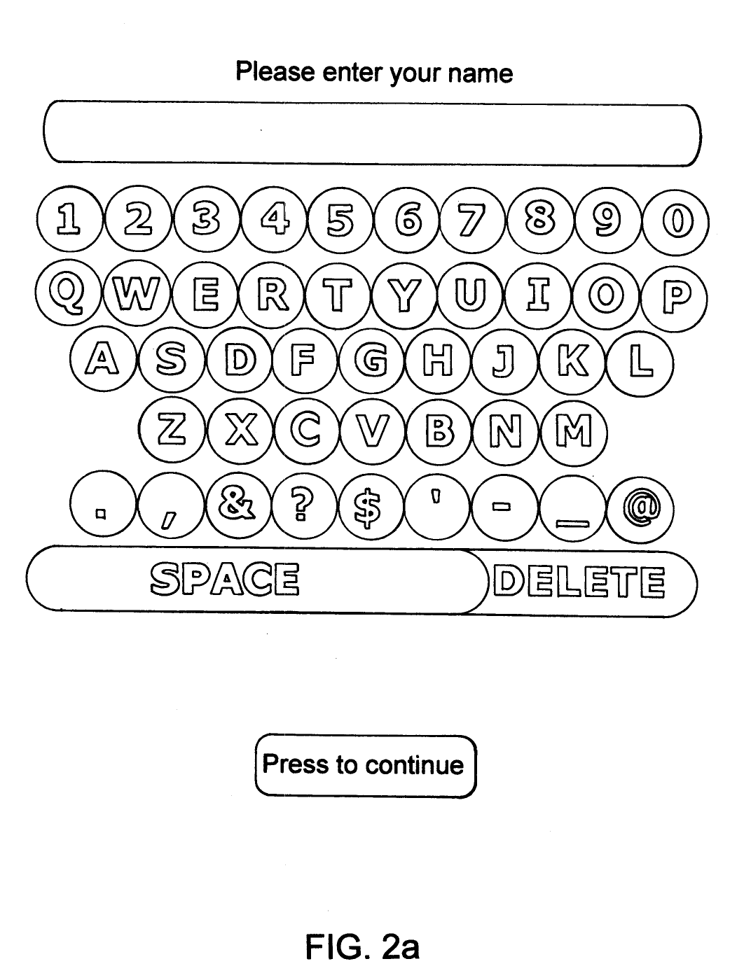

Referring now to FIG. 2, the basic operation of the system begins with a start command at 40, after which terms of service are displayed on the video display at 42. Touch sensitive buttons are displayed below the terms of service (not shown) for accepting or declining. If the user declines, by touching the button labeled “I Decline” (not shown), the program stops as indicated at 46 in FIG. 2. If the user accepts, by touching the button labeled “I Accept” (not shown), the program continues to one or more data entry screens as indicated at 48 in FIG. 2. An exemplary data entry screen is shown in FIG. 2A. Although the majority of information collected by the systems and methods of the invention is collected via the camera and microphone, it is useful to collect some data in alphanumeric form so that the audiovisual data may be easily collated, filed and forwarded without the need for voice recognition software. Types of data collected in this way may include data necessary to identify the person receiving long term care, next of kin, contact information, etc.

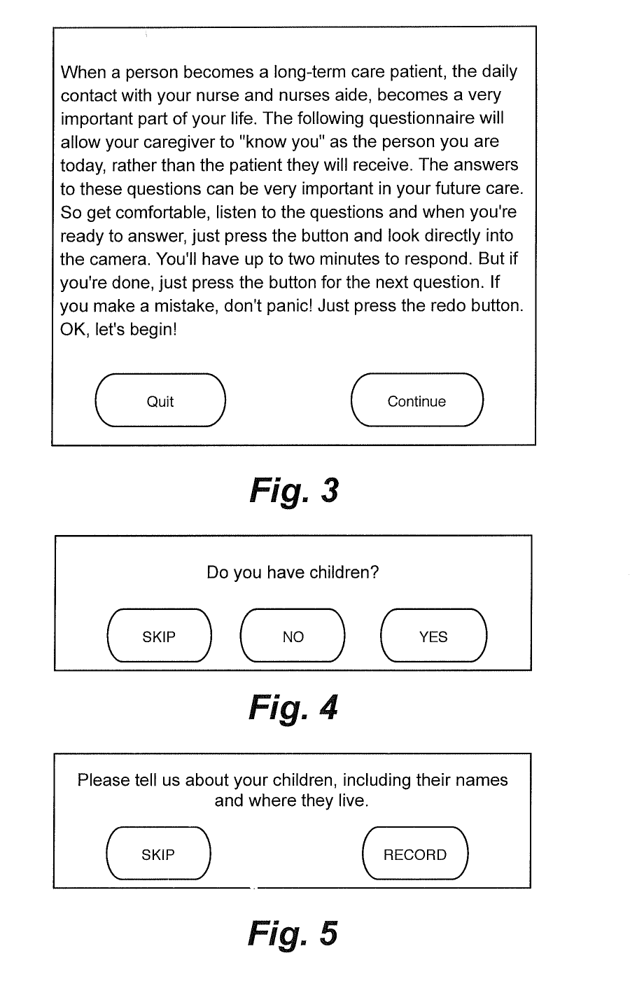

FIGS. 3-17 illustrate an audiovisual interview designed for a person who may later need care. According to an alternative application of the invention, someone other than the person needing care can be interviewed. Such a person may include a close friend or relative. Prior to beginning the interview, the person being interviewed will be asked to identify whether they are the person who may need future care and, if not, to describe their relationship to the person needing care.

Prior to proceeding to the audiovisual interview, it may also be desirable to provide an introduction screen such as that shown in FIG. 3. Preferably, the text shown in FIG. 3 has been read aloud and pre-recorded into an audio file, such as an mp3 file, which is played through the loudspeaker while this screen is being displayed. The introduction screen may be displayed in lieu of or in addition to the terms of service screen. It may be the first screen displayed (before the terms of service screen) and touching the button labeled “Continue” may constitute the “Start” indicated at 40 in FIG. 2.

Returning now to FIG. 2, the first question is played and displayed as indicated at 50 in FIG. 2. FIG. 4 shows an exemplary first question which does not require an audiovisual response. Here the question is “Do you have children?” and three responses are possible via touch sensitive buttons labeled “yes”, “no”, and “skip”. As will be apparent from the discussion of the following figures, the “skip” option is preferably provided as a response option to every question. This is because some questions may be irrelevant to the particular patient. Alternatively, some topics may be relevant but too painful to discuss. As illustrated in FIG. 2, after each question is answered or skipped at 52, it is determined at 54 whether more questions are to be posed. Questions and answers continue at 50 and 52 until it is determined at 54 that the questions are done.

The answers to the questions are saved in memory (14 in FIG. 1) until all questions have been answered or skipped. Then a disk is burned as illustrated in FIG. 2 at 56. The disk will contain data, preferably in the form of ASCII text regarding the data entries made at 48 in FIG. 2 and will include one or more audiovisual files. The audiovisual answers to questions are preferably preceded by an audio or audiovisual representation of the question being answered. The disk may be encoded with other data such as medical records, scanned photographs of the patient and the patient's family, etc. Preferably the disk is formatted with a menu system so that when it is placed in a disk player or computer a visual interactive menu appears so that the viewer can select all or parts of the disk to view.

FIG. 2 does not illustrate billing or the collection of fees from the user. However, such is preferably provided for and offered in a variety of plans. For example, a long term care provider can purchase a package of sessions per day or each client/user/patient can be billed directly for a single session.

As described above, an important feature of the invention is that it provides for the collection and preservation of non-traditional health care information in a medium which is easily accessible. Thus, according to the invention, much of the information collected is in the form of an audiovisual narrative by the patient or by a close friend or family member.

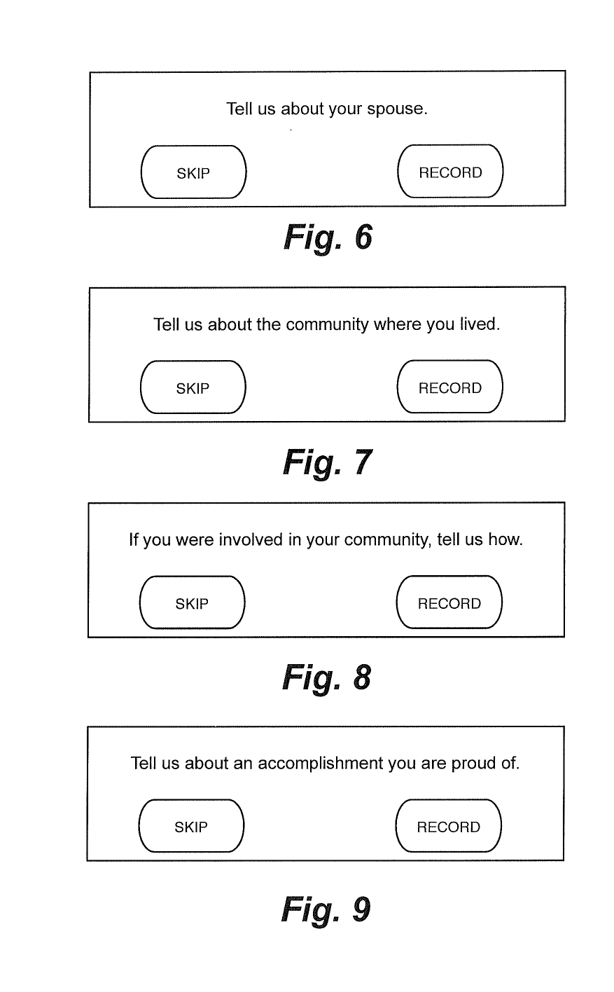

FIGS. 5-17 illustrate exemplary questions and requests for information which are open ended and allow the user to record an audiovisual narrative, preferably up to two minutes per response although different amounts of time may be provided for different questions. If desired, the user may be given the option of using as much time as they choose. Many of these questions/requests are in the form of “please tell us about . . . ”. For example, if the user answered positively to the question in FIG. 4 (“Do you have children?”), the request of FIG. 5 is displayed “Please tell us about your children . . . ”. The request in FIG. 5 also provides some prompting to the user as to what kind of information is desired, i.e. “including their names and where they live”. Other requests, such as those shown in FIGS. 6 and 7 are completely open-ended “tell us about your spouse” and “tell us about the community where you lived”. While the user is answering the question/request, the question/request may remain on the screen as semi-transparent overlay with the image of the user underneath it. The user may adjust the camera position to keep it pointed at their face or the camera may be self centering through a combination of hardware and software that recognized the location of a face in the frame and adjust the camera angle accordingly. If a two minute (or other time) limit is placed on the recording, a count down timer will also be displayed. At the end of the recording, and before the next question/request, the user is preferably presented with the choices of reviewing, saving, or redoing.

The requests shown in FIGS. 6-9 are designed to collect information about the history of the patient so that future caregivers can come to know the patient as an individual with a unique history, even though the patient may have lost the ability to communicate this information. The questions about community activity (FIG. 8) and proud accomplishments (FIG. 9) can elicit information that will inspire a caregiver to give more than the usual attention to this patient.

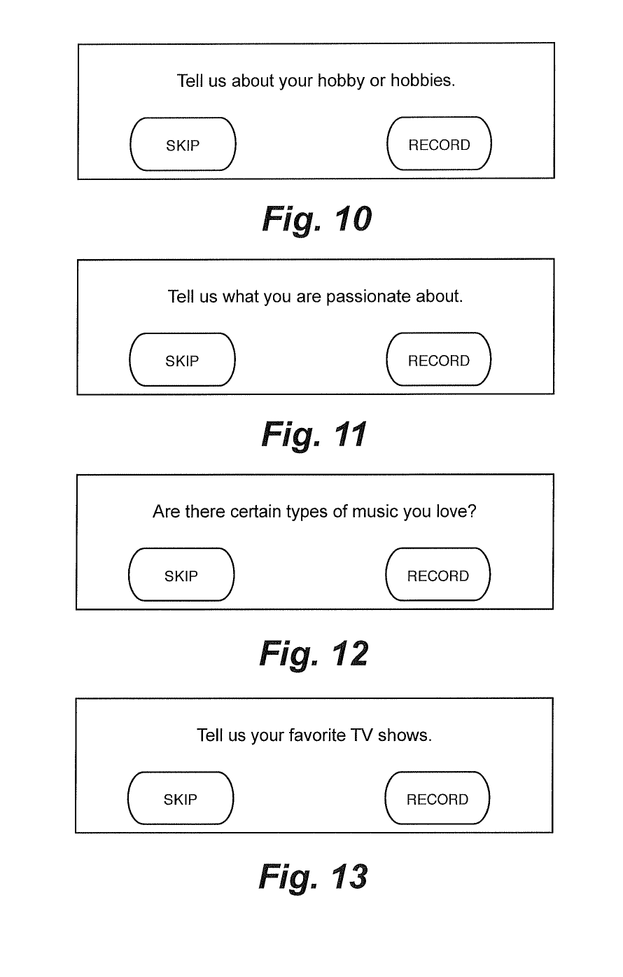

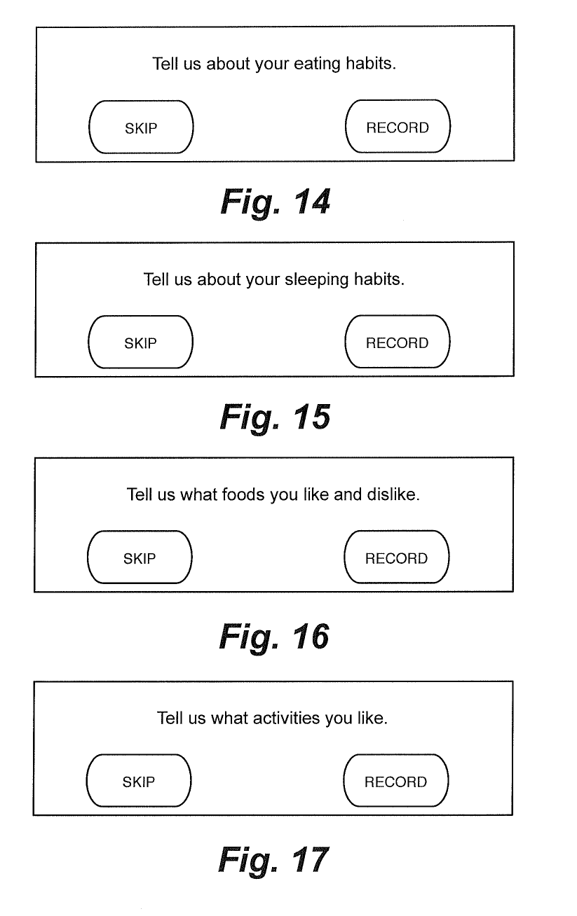

Other questions/requests are designed to elicit information about the patient's likes, dislikes, and special interests. For example, information about the patient's hobbies (FIG. 10), passionate interests (FIG. 11), favorite music (FIG. 12), and favorite TV shows (FIG. 13) can be advantageously applied by caregivers to lift the patient's spirits in ways that could not be done without this knowledge. Similarly, information about the patient's eating habits (FIG. 14), sleeping habits (FIG. 15), food preferences (FIG. 16), and favorite activities (FIG. 17) can be used to make the patient's day to day experience as comfortable and pleasing as possible.

After all information has been recorded, the recording session can be ended, and if desired, the entire recording session can be reviewed (not shown) before a disk is burned with the recording. While viewing the recorded session, the user may be given opportunities (not shown) to edit or alter the recording. The disk is preferably burned upon instruction (not shown) by the user to complete the session. In addition to, or in lieu of burning the disk, the recording session can be saved to a local hard disk or transmitted to a remote hard disk at one or more locations.

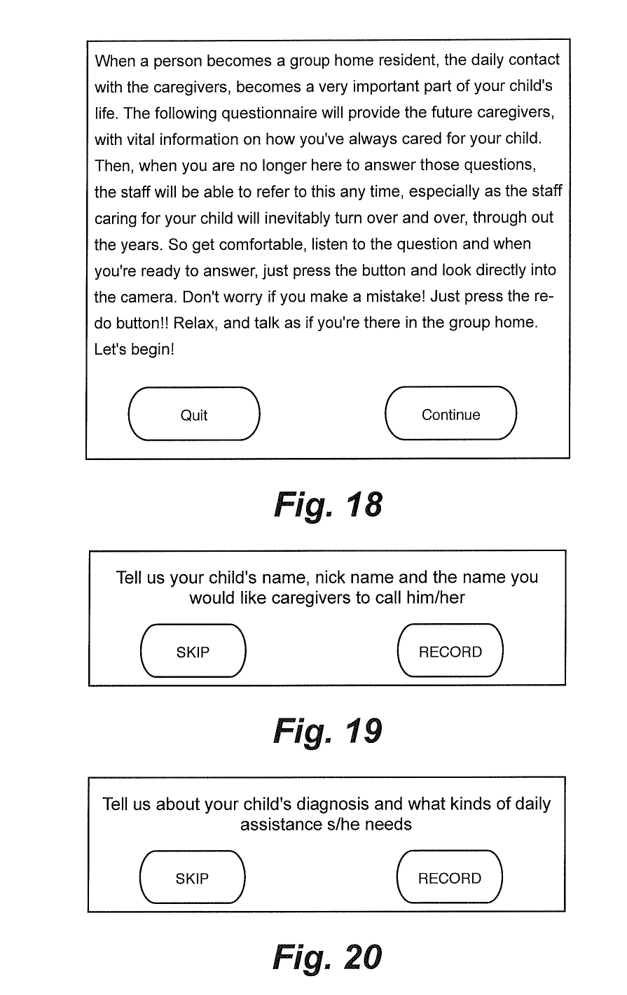

FIGS. 18-32 illustrate the second application of the methods of the invention where someone other than the person to receive care is interviewed. These figures also illustrate an application of the invention involving child care rather than elder care. In this application, the parent(s) of the child are interviewed about the child. As described above, the person being interviewed may be asked to describe their relationship to the person needing care.

FIG. 18 is an introductory screen which is similar to the introductory screen shown in FIG. 3 except that it refers to a child's group home residency rather than a patient's long-term care. FIG. 19 shows a request for information about the child's name and nickname and requests a recorded response. This request could also be made using a screen like that shown in FIG. 2B. If this were the only request for identifying information, the “skip” button would not be displayed.

FIG. 20 shows a request for information about the child's diagnosis or problem(s) and what kind of special assistance the child needs on a daily basis. Although this information may already be partially recorded in the child's medical history, the personal recounting this information can shed some valuable insight that could not be gleaned from the written medical records.

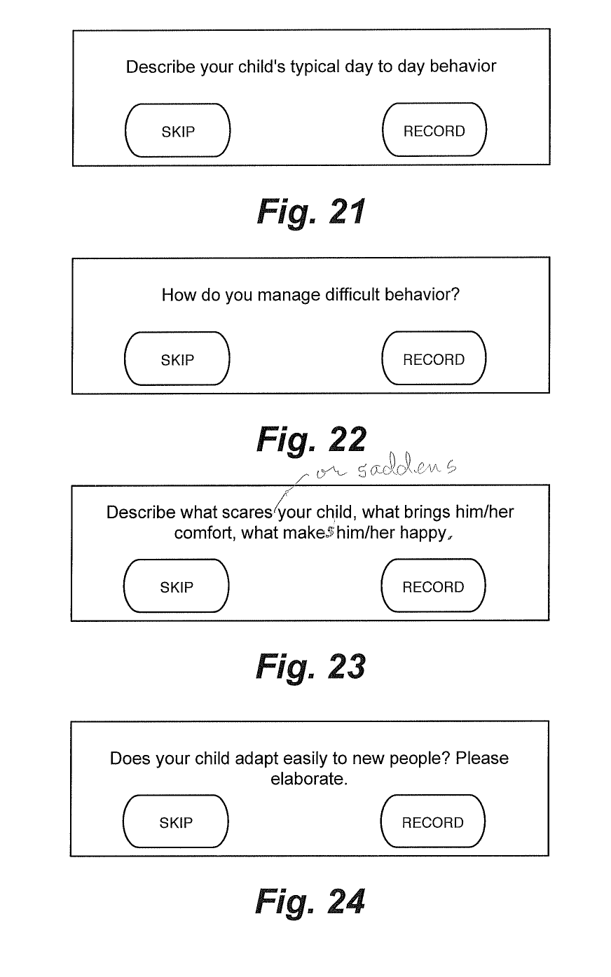

FIG. 21 shows an open ended request for a narrative about the child's day to day behavior. This is valuable information which is not likely to be found in a written medical record.

The question in FIG. 22 assumes that the child has a history of difficult behavior. This may not always be the case and the skip button may be the most appropriate response. Optionally, the parent(s) may choose to explain that difficult behavior is rare, how infrequent it is, what it usually involves, etc.

FIG. 23 illustrates a request for information about a child's moods (scared, comfortable, happy, sad). Here the parent(s) can explain what influences the child's moods in positive and negative ways.

Since a group home is, by definition, housing for a group of children having similar problems, it is necessary the all of the residents adapt to each other. The question illustrated in FIG. 24 requests a detailed description of how well the child adapts to new people.

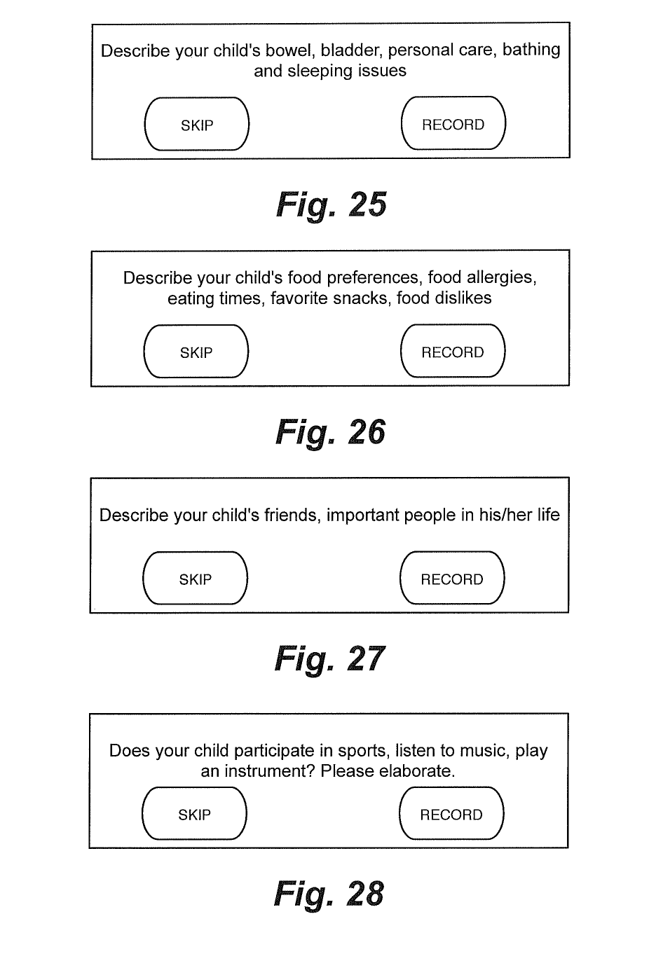

The requests for information in FIGS. 25 and 26 relate to the child's daily biological functions, e.g. bathroom use, sleeping habits, food preferences, allergies, etc. While some of this information might be found in a written medical record, much of it will not and the information is clearly important.

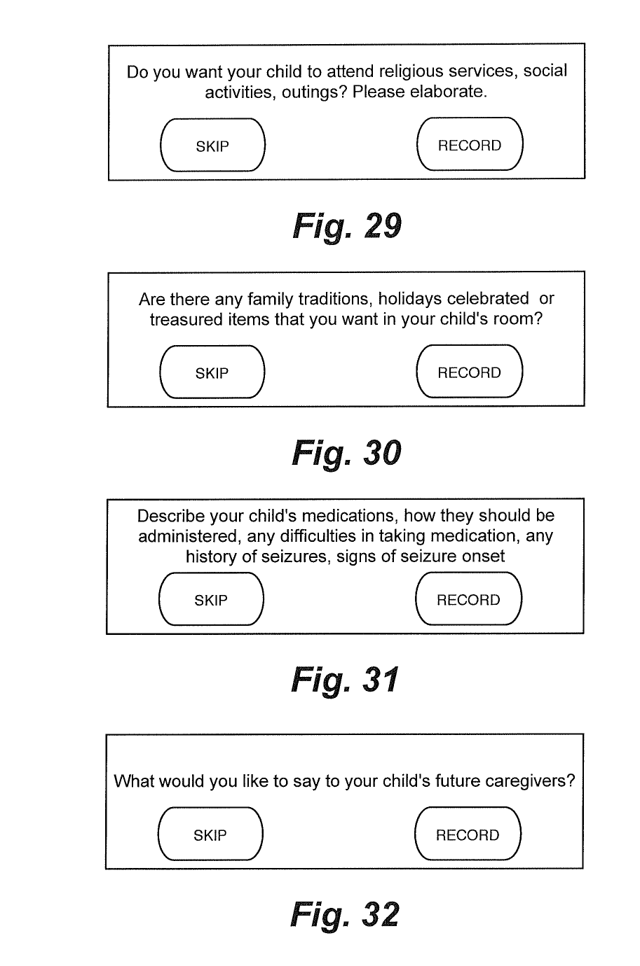

The request illustrated in FIG. 27 may elicit information which sheds light on the child's personality. FIGS. 28 and 29 illustrate open ended requests for information. FIG. 28 inquires about the child's activities, e.g. playing sports or a musical instrument. FIG. 29 asks about the activities the parent(s) want(s) the child to pursue, e.g. attending religious services, social activities, outings, etc.

FIG. 30 shows a question designed to obtain information that will allow the child to maintain some ties to his family via, traditions, holidays, or things, etc. FIG. 31 illustrates another request for medical information which may not be found in written medical records, e.g. whether the child likes to take medication mixed with applesauce, whether there are difficulties in taking medication, whether the child has seizures and what symptoms indicate the onset of a seizure.

The last question, illustrated in FIG. 32 allows the parent(s) to say anything that the parent(s) feel the future caregivers should know. This could include any information about the child or the child's past which could be useful to know in caring for the child.

As with the first application, after all information has been recorded, the recording session can be ended, and if desired, the entire recording session can be reviewed (not shown) before a disk is burned with the recording. While viewing the recorded session, the user may be given opportunities (not shown) to edit or alter the recording. The disk is preferably burned upon instruction (not shown) by the user to complete the session. In addition to, or in lieu of burning the disk, the recording session can be saved to a local hard disk or transmitted to a remote hard disk at one or more locations.

The following tables list other sample questions intended to elicit information and illustrate the type of information elicited in accord with the invention. Table 1 illustrates questions posed to a person diagnosed with an early stage of Alzheimers disease. Table 2 illustrates questions posed to a parent or parents of a child with special needs. Table 3 illustrates questions posed to a patient diagnosed with terminal cancer.

TABLE 1
Alzheimers Interview

Do you have children and would you like to tell us their names?
What would you like your nurse to remind you about your children?
Will they be able to visit you and if not would you like to explain why?
Have you ever lost a child?
Is it too painful to discuss or do you want to hear their name again?
Do you have a living spouse? If no, do you want to hear his or her name again?
Where do you live? What is your street name? And tell us something about the
community you live in:
Are you involved in your community and if yes how?
Do you work? and if so doing what and this includes being a stay at home mom.
Do you have any accomplishments you are proud of?
Do you have a hobby or hobbies that you would like to talk about?
Are you passionate about anything and if so what?
Is there a certain type of music you love to listen to and if yes what is it?
Do you have a favorite song that makes you feel warm?
Do you like holiday music?
Do you have music playing when you sleep? Do you need it playing in order to sleep and
If yes, what type?
Do you watch TV and if so do you have a preference for what type of shows or news?
Do you need it quiet in order to sleep?
Are you a stomach sleeper?
If no what type?
Do you like a lot of covers when you sleep? What is your preference?
Do you need your feet free from being covered?
Do you get up often at night to go to the bathroom? If yes how often?
How often do you have a bowel movement?
Are you laxative dependant? Will you please elaborate if the answer is yes.
Do you wear a brief? Which type do you like?
Do you need it completely dark to sleep?
Do you need a light on to sleep?
Do you go to bed early?:
Do you go to bed late? What time?
Do you typically eat a bedtime snack? If yes, what, and what time do you eat it?
Do you eat three meals a day: Please elaborate on your schedule.
Are there favorite foods you want? Please elaborate on these.
What foods do you dislike?
Do you drink coffee? How do you like it?
Do you drink Tea? How do you like that?
Do you have a favorite holiday? If so elaborate:
Are you typically a social or reserved person?
Are you sensitive about being touched anywhere?
Were there any traumas in your life that may affect your care?
Do you prefer a bath or a shower?
Do you exercise regularly? If yes please elaborate:
Do you play sports?
Did you have pets? If yes please elaborate with names and tell us whether or not
you'd like to be reminded of them.
Do you travel?: If yes elaborate:
Do you have a favorite soap or shampoo that you'd like your family to continue
buying for you? Please tell us what it is.
Do you have a comfort food? If yes what is it?
If you're female, do you wear makeup? If yes please elaborate with favorite
shades of lipstick, brands if important, nail polish, etc:
Are you modest? On a scale of 1-10 (1 being least modest, where do you fall?:
Do you wear slippers, sneakers or dress shoes? List what you like best.
What makes you smile and feel warm?:
What scares you?:
What depresses you?
What calms you?
What makes you laugh? Was there a word or family expression that comes to mind?
What annoys you?
If you're in the situation where you have to be placed in a chair at the nurses
station during the day, what would you want the nurses to know about you?
What if 1 or 2 nurses have to stay in the bathroom or shower with you? How will you
feel?
Do you use over the counter medications regularly? If so what are they and how
often do you take them?
How do you take your medications?
Crushed? Whole: In
Applesauce: In Yogurt: Or any other way?
Do you have a favorite flower? If yes please tell us what it is.
Do you have any allergies? If so, to what?
What would you say to yourself if you're rendered incapable sometime in the
future and you're now the patient?
What would you tell your nurses and your nurses aides?
What would you tell your Doctor?
What would you tell your family:
Is there anything additional that you would like to add that we did not discuss?

TABLE 2
Interview for parents with special needs children

Category 1. Personal data:
What is your child's name?
What do you call him or her?
What name do you want future caregivers to use?
What is your child's diagnosis?
Are there any “activities of daily living” that he or she will need assistance with ?
Is he or she compliant with the help offered? If no, how do you manage the
disagreements?
Category II. Behavior:
Let's discuss your child's “typical” day to day behavior.
How do you manage difficult behavior?
Is he or she modest?
Is your child strong willed?
What scares him or her and how do you comfort him or her in these situations?
What brings a joyful response and happiness?
What makes your child laugh?
What makes your child cry and how do you comfort him or her in these situations?
Is your child tactile defensive? If yes how do you manage this?
Does your child use abusive language? If yes how do you manage this?
Is s(he) inappropriate with the opposite sex? If yes, how do you manage this?
How do you know when your child is uncomfortable?
Is your child confined to a wheelchair; is there a position that is most comfortable?
Does your child have any repetitive habits and how do you manage these?
Is your child sensitive to sounds or smells?
What things set your child off?
How do you manage this?
Does your child easily adapt to new people? Please elaborate.
Category III. Bowel and bladder, personal care:
What are your child's typical bowel and bladder patterns?
Is he or she incontinent?
Does your child need assistance in the bathroom?
Does your child wear a brief? If yes, is there a particular brand you prefer?
Does your child prefer a bath or a shower?
Is there a brand of soap or shampoo that is his or her favorite?
Does your child dress him or herself?
What does your child like to wear?
What do you like your child to wear?
Is your child sensitive to any material?
Does your child sleep with a nightlight or with music or the TV ON?
Is there a certain position in bed that is most comfortable for him or her
Does your child sleep with an object that is important to him or her?
Category IV. Diet
Is your child allergic to any foods?
Does your child feed him or herself?
Does your child prepare his or her own meals?
What are your child's favorite foods?
Does your child have a “comfort” food?
What are the typical times for eating meals in your home?
Which foods does your child dislike?
Does he or she have a bedtime snack? If yes, what kind?
What are your child's sleep habits? Does he or she wake up early? Go to bed late?
Category V. Social activities:
Who is important in your child's life?
Does your child have a best friend?
Does your child participate in sports? Please elaborate.
Does your child like to listen to music? Which kind?
Is there a favorite holiday song that your child enjoys most?
Does your child like to watch TV? If so what shows or movies?
Does your child attend religious services? If yes do you want him or her taken to services
and where?
Does your child attend any social activities and do you want that continued?
Do you want your child taken on outings to the malls and other stores?
Are there important family traditions you want continued? Are holidays celebrated
with family or are there any ornaments or treasured decorations you want in your
child's room? If so, please elaborate.
Does your child have a pet that is or was important to him or her? If yes what is the pets
name and does the child like to talk about it?
Category VI. Medications:
If your child is on medication, how does he or she take it? Whole, crushed in
applesauce, or any other way. Are there any difficulties in taking the
medications?
If your child is prone to seizures and what are the signs of an oncoming seizure?
Is there anything else you would like to say to your child's future caregivers?
Category VII. Mom and dad:
Okay, now you can relax. Your lifestyle video care plan is complete. You have
made an important contribution to the future of your loved one. Thank you. Now
please consult with your video agent for further instruction.

TABLE 3
Interview with patient diagnosed with cancer

What is your diagnosis?
Thinking back, were they any signs and symptoms you may have ignored?
Do you know if any family members from generations past have had this?
Was there any trauma in your life that could potentially interfere with the
way you accept care?
How could your caregivers make you most comfortable?
Is there a place on your body that you don't like being touched?
On a scale from one to ten with 1 being the least modest, where do
you fall?
Is there something that you would never wear including cosmetics!
Do you need it dark and quiet to sleep or the noise of a TV or radio or
maybe some light?
Do you have children, if yes what are their names.
What would you like them to know about battling this disease?
Do you have any advice for them?
What is your most joyful family memory?
What makes you laugh?
Do you have an evening prayer that you say or said with your family?
If so, please recite it just the way you always have!
Do you have a favorite holiday song? If so, what is it?
Do you have a favorite flower?
Do you have a favorite food?
Do you have any pets that you would like to talk about?
Is there anything you would like to add or say to those who are watching
this video?
Okay, now you can relax. Your lifestyle video care plan is complete.
You have made an important contribution to the future care of you or
your loved one. Thank you, now please consult with your video agent
for further instructions.

There have been described and illustrated herein several embodiments of systems and methods for obtaining and preserving health care information. While particular embodiments of the invention have been described, it is not intended that the invention be limited thereto, as it is intended that the invention be as broad in scope as the art will allow and that the specification be read likewise. Thus, while particular applications (long term care and group home residency) have been disclosed, it will be appreciated that the invention could be applied to other future care situations as well. Thus, the invention can apply to any subject person requiring future care, not just patients and wards. In addition, while particular types of storage media have been disclosed, it will be understood any reliable portable storage medium capable of carrying audiovisual material can be used. In some applications it may be desirable to maintain a storage location containing the information of all clients in case the portable data storage of a particular client is lost or damaged. The back up data storage may be located at a central location or at one of several regional locations. In fact, it is not necessary in all circumstances that the portable disks be burned provided the central data storage is maintained. Also, while a touch sensitive screen is presently preferred, it will be recognized that a normal keyboard could be used. Accurate speech recognition software, if available, could be used in lieu of either a touch screen or a keyboard. Furthermore, while several specific sets of questions have been disclosed, these questions are exemplary of the types of questions contemplated by the invention. It will therefore be appreciated by those skilled in the art that yet other modifications could be made to the provided invention without deviating from its spirit and scope as claimed.

What is claimed is:

1. A method of obtaining and preserving health care information about a subject, comprising:
pre-recording questions/requests designed to elicit the health care information;
playing the pre-recorded questions/requests to a person knowledgeable about the information;
interactively making an audiovisual recording of the person answering the questions/requests; and
upon conclusion of said making an audiovisual recording, immediately preserving the audiovisual recording in a machine readable medium.

2. The method according to claim 1, wherein:
the health care information includes personal information about the subject.

3. The method according to claim 2, wherein:
the personal information includes information about the subject's eating habits.

4. The method according to claim 2, wherein:
the personal information includes information about the subject's past accomplishments.

5. The method according to claim 2, wherein:
the personal information includes information about the subject's likes and dislikes.

6. The method according to claim 2, wherein:
the personal information includes information about the subject's sleeping habits.

7. The method according to claim 2, wherein:
the personal information includes information about assistance needed by the subject on a daily basis.

8. The method according to claim 2, wherein:
the personal information includes information about the subject's past behavior.

9. The method according to claim 2, wherein:
the personal information includes information about the subject's interpersonal relationships.

10. The method according to claim 2, wherein:
the personal information includes information about what makes the subject happy.

11. The method according to claim 2, wherein:
the personal information includes information about what makes the subject sad.

12. The method according to claim 2, wherein:
the personal information includes information about activities engaged in by the subject.

13. The method according to claim 1, wherein:
the person answering is the subject.

14. The method according to claim 1, wherein:
the playing the pre-recorded questions/requests and the making an audiovisual recording are performed with an audiovisual kiosk.

15. A method of obtaining and preserving health care information about a subject, comprising:
pre-recording questions/requests designed to elicit the health care information;
playing the pre-recorded questions/requests to a person knowledgeable about the information;
interactively making an audiovisual recording of the person answering the questions/requests; and
upon concluding said making an audiovisual recording, immediately preserving the audiovisual recording in a portable medium, wherein
the health care information includes personal information about the subject including
information about the subject's eating habits,
information about the subject's past accomplishments,
information about the subject's likes and dislikes,
information about the subject's sleeping habits,
information about assistance needed by the subject on a daily basis,
information about the subject's past behavior,
information about the subject's interpersonal relationships,
information about what makes the subject happy.
information about what makes the subject sad, and
information about activities engaged in by the subject.

16. A system for obtaining and preserving health care information about a subject, comprising:
a processor having a plurality of outputs and inputs;
a video camera coupled to an input of said processor;
a microphone coupled to an input of said processor;
a video display coupled to an output of said processor;
a loudspeaker coupled to an output of said processor;
a machine readable memory medium coupled to an output of said processor; and
a memory bidirectionally coupled to said processor, said memory storing an audiovisual interactive program, said audiovisual interactive program including pre-recorded questions/requests designed to elicit the health care information, instructions to said processor for playing the pre-recorded questions/requests through said video display and said loudspeaker, instructions for making an audiovisual recording via said video camera and said microphone of a person answering the questions/requests, and instructions for preserving the audiovisual recording in said portable memory medium, wherein
said processor causes said pre-recorded questions/requests to be played through said loudspeaker and said video display and causes answers to said questions/requests detected by said video camera and said microphone to be recorded on said machine readable memory medium.

17. A system according to claim 16, wherein:
the health care information includes personal information about the subject.

18. A system according to claim 16, further comprising:
a touch input device coupled to an input of said processor.

19. A system according to claim 18, wherein:
said touch input device is a touch sensitive screen overlying said video display.

20. A system according to claim 16, wherein:
said machine readable memory medium is a CDR (compact disk recordable).

21. A system according to claim 16, wherein:
said machine readable memory medium is a DVDR (digital video disk recordable).
